(19) United States
(12) Patent Application Publication
(10) Pub. No.: US 2007/0013889 A1
(43) Pub. Date: Jan. 18, 2007

(54) Lithographic apparatus, device manufacturing method and device manufactured thereby having an increase in depth of focus

(75) Inventors: Laurentius Catrinus Jorritsma, Helmond (NL); Johannes Jacobus Matheus Baselmans, Oirschot (NL); Arno Jan Bleeker, Westerhoven (NL); Jacob Fredrik Friso Klinkhamer, Delft (NL)

Correspondence Address: STERNE, KESSLER, GOLDSTEIN & FOX PLLC, 1100 NEW YORK AVENUE, N.W., WASHINGTON, DC, 20005, US

(73) Assignee: ASML Netherlands B.V., Veldhoven (NL)

(21) Appl. No.: 11/179,056

(22) Filed: Jul. 12, 2005

(51) Int. Cl. G03B 27/54

(52) U.S. Cl. 355/67; 355/53

(57) ABSTRACT

A lithographic apparatus comprises an illumination system for supplying a beam of radiation, an array of individually controllable elements serving to impart the beam with a pattern in its cross-section, a substrate table for supporting a substrate, and a projection system for projecting the patterned beam onto a target portion of the substrate. The beam of radiation comprises a plurality of beam components. The plurality of beam components includes a first beam component having a first frequency spectrum about a first frequency and at least a second beam component having a second frequency spectrum about a second frequency. The second frequency is different from the first frequency. The projection system focuses the first and second beam components at different heights with respect to the substrate table.

### BACKGROUND

1. Field

The present invention relates to a lithographic apparatus and a method for manufacturing a device.

2. Related Art

A lithographic apparatus is a machine that applies a desired pattern onto a substrate or part of a substrate. A lithographic apparatus can be used, for example, in the manufacture of flat panel displays, integrated circuits (ICs) and other devices involving fine structures. In a conventional apparatus, a patterning device, which can be referred to as a mask or a reticle, can be used to generate a circuit pattern corresponding to an individual layer of a flat panel display (or other device). This pattern can be transferred on (part of) the substrate (e.g., a glass plate), via imaging onto a layer of radiation-sensitive material (resist) provided on the substrate.

Instead of a circuit pattern, the patterning means can be used to generate other patterns, for example a color filter pattern or a matrix of dots. Instead of a mask, the patterning device can comprise a patterning array that comprises an array of individually controllable elements. The pattern can be changed more quickly and for less cost in such a system compared to a mask-based system.

A flat panel display substrate is typically rectangular in shape. Lithographic apparatus designed to expose a substrate of this type can provide an exposure region that covers a full width of the rectangular substrate, or which covers a portion of the width (for example half of the width). The substrate can be scanned underneath the exposure region, while the mask or reticle is synchronously scanned through the beam. In this way, the pattern is transferred to the substrate. If the exposure region covers the full width of the substrate then exposure can be completed with a single scan. If the exposure region covers, for example, half of the width of the substrate, then the substrate can be moved transversely after the first scan, and a further scan is typically performed to expose the remainder of the substrate.

A lithographic apparatus can comprise a projection system for imaging the circuit pattern onto the target portion on the substrate. The projection system can comprise one or more lenses arranged to focus the pattern onto an upper surface of a substrate. In the case of a lithographic apparatus having an array of individually controllable elements, rather than relying upon a preformed mask to impart a pattern to a beam, control signals are delivered to the array of controllable elements so as to control the state of those elements, thereby to pattern the beam. The pattern imparted to the beam can thus comprise an array of spots. Each spot can correspond to, and be controlled by, a single element or a group of elements within the array. The projection system can be arranged to image the array of spots, such that they are focused onto the upper surface of the substrate. The spots can be circular or disc shaped, or of any other shape.

The lithographic apparatus can include an illumination system for supplying a beam of radiation. This beam can be used to illuminate the array of individually controllable elements, or alternatively the mask. The patterned beam can be focused by the projection system onto the upper surface of the substrate.

The depth of focus of a focused beam of radiation is defined as the range of distance along the axis of the beam (the Z-axis) for which an acceptably sharp image can be imaged onto the surface of a substrate placed in the path of the beam.

The beam of radiation can be generated from a radiation source, for instance a laser. Increasing the bandwidth of a laser can introduce fading along the Z-axis when the beam is focused onto a surface, (Z-fading). A reasonable degree of Z-fading can increase the depth of focus of a pattern imaged onto the upper surface of a substrate in lithography. However, excessive uncontrolled Z-fading can lead to blurring of the image.

The focus budget for lithographic apparatus is the required range along the Z-axis within which an acceptably sharp pattern is to be imaged. For some lithographic apparatus applications, for instance fabricating flat panel displays, the focus budget can be very close to the depth of focus of the lithographic apparatus. Therefore, it can be desirable to increase the depth of focus of the beam in order to increase the margin of error along the Z-axis when positioning the substrate.

The focus budget can be affected by a variety of parameters specific to the application of the lithographic apparatus. These can include the baking temperature of the substrate, the time between exposure of the substrate and baking, the thickness of photo resist layers applied to the substrate and how the substrate is etched in later processing steps. Therefore, it is often desirable that the depth of focus of the lithographic apparatus is as large as possible. By doing this, the accuracy of the width of each line will be robust to variations in the processing parameters.

Therefore, what is needed is a system and method that provide a lithographic apparatus having an increased depth of focus compared with a conventional lithographic apparatus for imaging a patterned beam of radiation onto a target portion of a substrate.

### SUMMARY

According to one embodiment of the present invention, there is provided a lithographic apparatus comprising an illumination system, an array of individually controllable elements, a substrate table, and a projection system. The illumination system supplies a beam of radiation. The array of individually controllable elements patterns the beam. The substrate table supports a substrate. The projection system projects the patterned beam onto a target portion of the substrate. The beam of radiation comprises a plurality of beam components including a first beam component having a first frequency spectrum about a first frequency and at least a second beam component having a second frequency spectrum about a second frequency, the second frequency being different from the first frequency. The projection system focuses the first and second beam components at different heights with respect to the substrate table.

In one example, by providing a beam comprising a plurality of beam components having frequency spectra about different frequencies the depth of focus of the patterned beam is increased. This provides an increase in the margin between the depth of focus of the beam and the focus budget of the lithographic apparatus allowing the positioning of the substrate along the Z-axis to be less critical. Furthermore, the present inventors have realized that for maskless lithography increasing the depth of focus is particularly desirable for increasing the accuracy of patterns imaged onto a surface of a substrate. For instance, variation in the width of lines can be reduced.

The beam of radiation thus comprises at least two beam components, each having a respective frequency spectrum about a different respective frequency. In certain embodiments the beam comprises more than two components, for example the beam of radiation can comprise three, four, or five beam components, or even more. The projection system can be arranged to focus one beam component at a height corresponding to a surface of the target portion. By providing at least three beam components it is possible to provide at least one beam focused onto the surface of the substrate, and at least one beam component focused above and below the surface of the substrate. This provides a broad depth of focus.

In one example, the frequency spectra of the beam components can overlap. For example, the difference between the first frequency and the second frequency can be less than about 4×10¹⁵ Hz. It is desirable that the differences between the nominal frequencies for each beam components are small in order that the composite beam effectively images a single pattern onto the surface of the substrate having an increased depth of focus.

In one example, the projection system can be arranged to project the patterned beam as an array of radiation spots. The projection system can comprise an array of lenses arranged to receive the patterned beam.

In one example, the illumination system can be arranged such that the beam of radiation comprises all of the beam components simultaneously. Alternatively, the illumination system can be arranged to supply the plurality of beam components sequentially. When arranged to supply the plurality of beam components sequentially, the illumination system can be arranged such that the beam of radiation comprises a series of pulses of radiation, each pulse of radiation comprising a different beam component.

In one example, the illumination system can comprise a plurality of radiation sources, each source being arranged to provide a respective one of the beam components. Each radiation source can comprise a respective laser. When the illumination system comprises a plurality of radiation sources, the illumination system can further comprise a beam deflection system arranged to receive the plurality of beam components and to direct each beam component along a single common beam path. In one example, directing each beam component along a single common beam path allows a single beam is provided to the patterning system having an increased depth of focus. This, therefore, does not require modification of the projection system.

In one example, the illumination system can be arranged to supply the beam of radiation to a plurality of arrays of individually controllable elements. This allows for the fabrication of devices using large area substrates, such as FPDs, which require a number of patterning systems to cover the full width of the substrate in a scanning system. This reduces the cost of the lithographic apparatus.

According to a further embodiment of the present invention there is provided a device manufacturing method comprising the following steps. Using an array of individually controllable elements to impart a beam with a pattern in its cross-section. Projecting the patterned beam of radiation onto a target portion of a substrate. The beam of radiation comprises a plurality of beam components including a first beam component having a first frequency spectrum about a first frequency and at least a second beam component having a second frequency spectrum about a second frequency. The second frequency is different from the first frequency. The first and second beam components are focused at different heights with respect to the substrate table.

In one example, the device manufacturing method can comprise projecting the plurality of beam components simultaneously. Alternatively, the device manufacturing method can comprise projecting the plurality of beam components sequentially. For sequential operation the device manufacturing method the beam of radiation can comprise a series of pulses of radiation, each pulse of radiation comprising a separate beam component.

In one example, the device manufacturing method can further comprise receiving the plurality of beam components from a plurality of respective radiation sources, and deflecting each beam component along a single common beam path to the array of individually controllable elements.

According to a further embodiment of the present invention, there is provided a lithographic apparatus comprising an illumination system, an array of individually controllable elements, a substrate table, a control system, and a projection system. The illumination system supplies a beam of radiation. The array of individually controllable elements pattern the beam. The substrate table supports a substrate. The projection system projects the patterned beam onto a target portion of the substrate. At least one of the projection system and the substrate table is controllable to adjust a separation between the projection system and a supported substrate to adjust a focus height of the projected beam relative to the substrate. The control system controls the substrate table to vary the focus height while a constant pattern is imparted to the beam.

In one example, an increase in the depth of focus for a maskless lithographic apparatus can be achieved using a beam having a single frequency spectrum about a single frequency.

According to a further embodiment of the present invention, there is provided a device manufacturing method comprising the following steps. Using an array of individually controllable elements to impart a beam with a pattern in its cross section. Projecting the patterned beam of radiation onto a target portion of a substrate. Sequentially focusing the patterned beam at a plurality of different heights with respect to a surface of the substrate and, for each focus height, projecting the patterned beam onto a common target portion of the substrate as a corresponding array of radiation spots.

In one example, the device manufacturing method can further comprise using a projection system to focus and project the patterned beam and effecting relative movement between the projection system and the substrate to focus the patterned beam at the plurality of different heights. Alternatively, or in addition the device manufacturing method can further comprise supporting the substrate on a substrate table and moving the substrate table to achieve the relative movement.

According to a further aspect of the present invention there is provided a flat panel display manufactured using a method as described above.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate one or more embodiments of the present invention and, together with the description, further serve to explain the principles of the present invention and to enable a person skilled in the pertinent art to make and use the present invention.

FIG. 1 depicts a lithographic apparatus, according to one embodiment of the present invention.

FIG. 2 depicts a portion of a projection system, according to one embodiment of the present invention.

FIG. 3 depicts a depth of focus for a beam, according to one embodiment of the present invention.

FIG. 4 depicts the frequency spectrum of a beam, according to one embodiment of the present invention.

FIG. 5 depicts a beam delivery system, according to one embodiment of the present invention.

FIG. 6 depicts a depth of focus for a beam, according to one embodiment of the present invention.

The present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

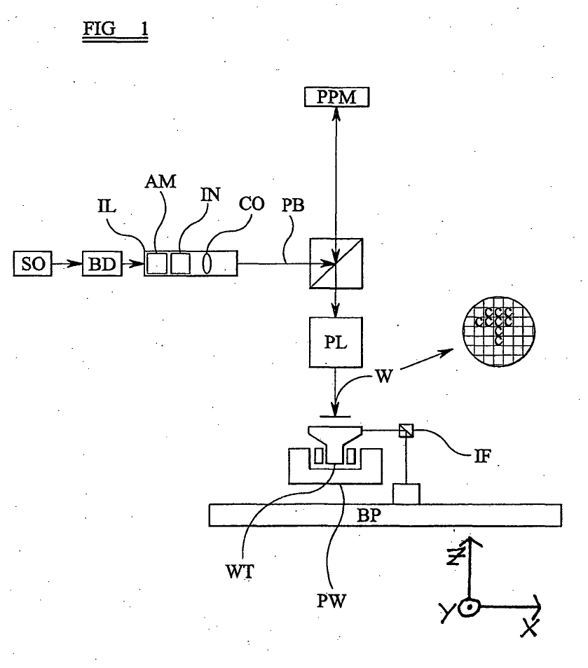

FIG. 1 schematically depicts The lithographic apparatus of one embodiment of the present invention. The apparatus comprises an illumination system IL, a patterning device PD, a substrate table WT, and a projection system PS. The illumination system (illuminator) IL is configured to condition a radiation beam B (e.g., UV radiation).

The patterning device PD (e.g., a reticle or mask or an array of individually controllable elements) modulates the beam. In general, the position of the array of individually controllable elements will be fixed relative to the projection system PS. However, it can instead be connected to a positioner configured to accurately position the array of individually controllable elements in accordance with certain parameters.

The substrate table WT is constructed to support a substrate (e.g., a resist-coated substrate) W and connected to a positioner PW configured to accurately position the substrate in accordance with certain parameters.

The projection system (e.g., a refractive projection lens system) PS is configured to project the beam of radiation modulated by the array of individually controllable elements onto a target portion C (e.g., comprising one or more dies) of the substrate W.

The illumination system can include various types of optical components, such as refractive, reflective, magnetic, electromagnetic, electrostatic or other types of optical components, or any combination thereof, for directing, shaping, or controlling radiation.

The term “patterning device” or “contrast device” used herein should be broadly interpreted as referring to any device that can be used to modulate the cross-section of a radiation beam, such as to create a pattern in a target portion of the substrate. The devices can be either static patterning devices (e.g., masks or reticles) or dynamic (e.g., arrays of programmable elements) patterning devices. For brevity, most of the description will be in terms of a dynamic patterning device, however it is to be appreciated that a static pattern device can also be used without departing from the scope of the present invention.

It should be noted that the pattern imparted to the radiation beam may not exactly correspond to the desired pattern in the target portion of the substrate, for example if the pattern includes phase-shifting features or so called assist features. Similarly, the pattern eventually generated on the substrate may not correspond to the pattern formed at any one instant on the array of individually controllable elements. This can be the case in an arrangement in which the eventual pattern formed on each part of the substrate is built up over a given period of time or a given number of exposures during which the pattern on the array of individually controllable elements and/or the relative position of the substrate changes.

Generally, the pattern created on the target portion of the substrate will correspond to a particular functional layer in a device being created in the target portion, such as an integrated circuit or a flat panel display (e.g., a color filter layer in a flat panel display or a thin film transistor layer in a flat panel display). Examples of such patterning devices include, e.g., reticles, programmable mirror arrays, laser diode arrays, light emitting diode arrays, grating light valves, and LCD arrays.

Patterning devices whose pattern is programmable with the aid of electronic means (e.g., a computer), such as patterning devices comprising a plurality of programmable elements (e.g., all the devices mentioned in the previous sentence except for the reticle), are collectively referred to herein as “contrast devices.” In one example, the patterning device comprises at least 10 programmable elements, e.g., at least 100, at least 1000, at least 10000, at least 100000, at least 1000000, or at least 10000000 programmable elements.

A programmable mirror array can comprise a matrix-addressable surface having a viscoelastic control layer and a reflective surface. The basic principle behind such an apparatus is that, e.g., addressed areas of the reflective surface reflect incident light as diffracted light, whereas unaddressed areas reflect incident light as undiffracted light. Using an appropriate spatial filter, the undiffracted light can be filtered out of the reflected beam, leaving only the diffracted light to reach the substrate. In this manner, the beam becomes patterned according to the addressing pattern of the matrix-addressable surface.

It will be appreciated that, as an alternative, the filter can filter out the diffracted light, leaving the undiffracted light to reach the substrate.

An array of diffractive optical MEMS devices (micro-electro-mechanical system devices) can also be used in a corresponding manner. In one example, a diffractive optical MEMS device is comprised of a plurality of reflective ribbons that can be deformed relative to one another to form a grating that reflects incident light as diffracted light.

A further alternative example of a programmable mirror array employs a matrix arrangement of tiny mirrors, each of which can be individually tilted about an axis by applying a suitable localized electric field, or by employing piezoelectric actuation means. Once again, the mirrors are matrix-addressable, such that addressed mirrors reflect an incoming radiation beam in a different direction to unaddressed mirrors; in this manner, the reflected beam can be patterned according to the addressing pattern of the matrix-addressable mirrors. The required matrix addressing can be performed using suitable electronic means.

Another example PD is a programmable LCD array.

The lithographic apparatus can comprise one or more contrast devices. For example, it can have a plurality of arrays of individually controllable elements, each controlled independently of each other. In such an arrangement, some or all of the arrays of individually controllable elements can have at least one of a common illumination system (or part of an illumination system), a common support structure for the arrays of individually controllable elements, and/or a common projection system (or part of the projection system).

In an example, such as the embodiment depicted in FIG. 1, the substrate W has a substantially circular shape, optionally with a notch and/or a flattened edge along part of its perimeter. In an example, the substrate has a polygonal shape, e.g., a rectangular shape.

In example where the substrate has a substantially circular shape include examples where the substrate has a diameter of at least 25 mm, for instance at least 50 mm, at least 75 mm, at least 100 mm, at least 125 mm, at least 150 mm, at least 175 mm, at least 200 mm, at least 250 mm, or at least 300 mm. In an embodiment, the substrate has a diameter of at most 500 mm, at most 400 mm, at most 350 mm, at most 300 mm, at most 250 mm, at most 200 mm, at most 150 mm, at most 100 mm, or at most 75 mm.

In examples where the substrate is polygonal, e.g., rectangular, include examples where at least one side, e.g., at least 2 sides or at least 3 sides, of the substrate has a length of at least 5 cm, e.g., at least 25 cm, at least 50 cm, at least 100 cm, at least 150 cm, at least 200 cm, or at least 250 cm.

In one example, at least one side of the substrate has a length of at most 1000 cm, e.g., at most 750 cm, at most 500 cm, at most 350 cm, at most 250 cm, at most 150 cm, or at most 75 cm.

In one example, the substrate W is a wafer, for instance a semiconductor wafer. In one example, the wafer material is selected from the group consisting of Si, SiGe, SiGeC, SiC, Ge, GaAs, InP, and InAs. In one example, the wafer is a III/V compound semiconductor wafer. In one example, the wafer is a silicon wafer. In an embodiment, the substrate is a ceramic substrate. In one example, the substrate is a glass substrate. In one example, the substrate is a plastic substrate. In one example, the substrate is transparent (for the naked human eye). In one example, the substrate is colored. In one example, the substrate is absent a color.

The thickness of the substrate can vary and, to an extent, can depend, e.g., on the substrate material and/or the substrate dimensions. In one example, the thickness is at least 50 μm, e.g., at least 100 μm, at least 200 μm, at least 300 μm, at least 400 μm, at least 500 μm, or at least 600 μm. In one example, the thickness of the substrate is at most 5000 μm, e.g., at most 3500 μm, at most 2500 μm, at most 1750 μm, at most 1250 μm, at most 1000 μm, at most 800 μm, at most 600 μm, at most 500 μm, at most 400 μm, or at most 300 μm.

The substrate referred to herein can be processed, before or after exposure, in for example a track (a tool that typically applies a layer of resist to a substrate and develops the exposed resist), a metrology tool, and/or an inspection tool. In one example, a resist layer is provided on the substrate.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein can be considered as synonymous with the more general term “projection system.”

The projection system can image the pattern on the array of individually controllable elements, such that the pattern is coherently formed on the substrate. Alternatively, the projection system can image secondary sources for which the elements of the array of individually controllable elements act as shutters. In this respect, the projection system can comprise an array of focusing elements such as a micro lens array (known as an MLA) or a Fresnel lens array, e.g., to form the secondary sources and to image spots onto the substrate. In one example, the array of focusing elements (e.g., MLA) comprises at least 10 focus elements, e.g., at least 100 focus elements, at least 1000 focus elements, at least 10000 focus elements, at least 100000 focus elements, or at least 1000000 focus elements. In one example, the number of individually controllable elements in the patterning device is equal to or greater than the number of focusing elements in the array of focusing elements. In one example, one or more (e.g., 1000 or more, the majority, or about each) of the focusing elements in the array of focusing elements can be optically associated with one or more of the individually controllable elements in the array of individually controllable elements, e.g., with 2 or more of the individually controllable elements in the array of individually controllable elements, such as 3 or more, 5 or more, 10 or more, 20 or more, 25 or more, 35 or more, or 50 or more. In one example, the MLA is movable (e.g., with the use of actuators) at least in the direction to and away from the substrate, e.g., with the use of one or more actuators. Being able to move the MLA to and away from the substrate allows, e.g., for focus adjustment without having to move the substrate.

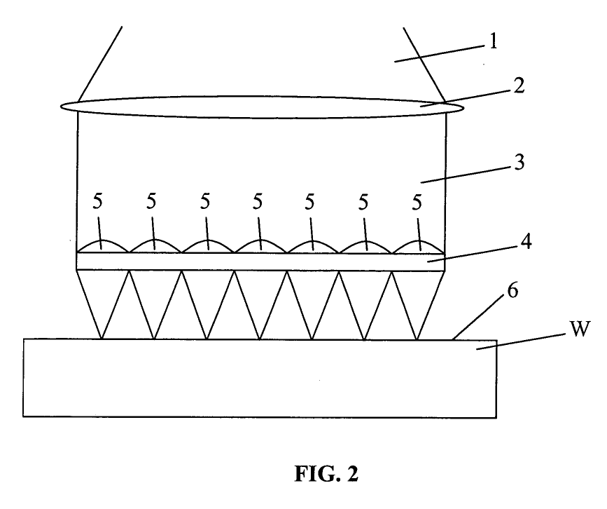

As herein depicted in FIGS. 1 and 2, the apparatus is of a reflective type (e.g., employing a reflective array of individually controllable elements). Alternatively, the apparatus can be of a transmissive type (e.g., employing a transmissive array of individually controllable elements).

The lithographic apparatus can be of a type having two (dual stage) or more substrate tables. In such “multiple stage” machines, the additional tables can be used in parallel, or preparatory steps can be carried out on one or more tables while one or more other tables are being used for exposure.

The lithographic apparatus can also be of a type wherein at least a portion of the substrate can be covered by an “immersion liquid” having a relatively high refractive index, e.g., water, so as to fill a space between the projection system and the substrate. An immersion liquid can also be applied to other spaces in the lithographic apparatus, for example, between the patterning device and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring again to FIG. 1, the illuminator IL receives a radiation beam from a radiation source SO. In one example, the radiation source provides radiation having a wavelength of at least 5 nm, e.g., at least 10 nm, at least 50 nm, at least 100 nm, at least 150 nm, at least 175 nm, at least 200 nm, at least 250 nm, at least 275 nm, at least 300 nm, at least 325 nm, at least 350 nm, or at least 360 nm. In one example, the radiation provided by radiation source SO has a wavelength of at most 450 nm, e.g., at most 425 nm, at most 375 nm, at most 360 nm, at most 325 nm, at most 275 nm, at most 250 nm, at most 225 nm, at most 200 nm, or at most 175 nm. In one example, the radiation has a wavelength including 436 nm, 405 nm, 365 nm, 355 nm, 248 nm, 193 nm, 157 nm, and/or 126 mm. In one example, the radiation includes a wavelength of around 365 nm or around 355 nm. In one example, the radiation includes a broad band of wavelengths, for example encompassing 365, 405, and 436 nm. A 355 mm laser source could be used. The source and the lithographic apparatus can be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source can be an integral part of the lithographic apparatus, for example when the source is a mercury lamp. The source SO and the illuminator IL, together with the beam delivery system BD if required, can be referred to as a radiation system.

The illuminator IL, can comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL can comprise various other components, such as an integrator IN and a condenser CO. The illuminator can be used to condition the radiation beam to have a desired uniformity and intensity distribution in its cross-section. The illuminator IL, or an additional component associated with it, can also be arranged to divide the radiation beam into a plurality of sub-beams that can, for example, each be associated with one or a plurality of the individually controllable elements of the array of individually controllable elements. A two-dimensional diffraction grating can, for example, be used to divide the radiation beam into sub-beams. In the present description, the terms “beam of radiation” and “radiation beam” encompass, but are not limited to, the situation in which the beam is comprised of a plurality of such sub-beams of radiation.

The radiation beam B is incident on the patterning device PD (e.g., an array of individually controllable elements) and is modulated by the patterning device. Having been reflected by the patterning device PD, the radiation beam B passes through the projection system PS, which focuses the beam onto a target portion C of the substrate W. With the aid of the positioner PW and position sensor IF2 (e.g., an interferometric device, linear encoder, capacitive sensor, or the like), the substrate table WT can be moved accurately, e.g., so as to position different target portions C in the path of the radiation beam B. Where used, the positioning means for the array of individually controllable elements can be used to correct accurately the position of the patterning device PD with respect to the path of the beam B, e.g., during a scan.

In one example, movement of the substrate table WT is realized with the aid of a long-stroke module (course positioning) and a short-stroke module (fine positioning), which are not explicitly depicted in FIG. 1. In one example, the apparatus is absent at least a short stroke module for moving substrate table WT. A similar system can also be used to position the array of individually controllable elements. It will be appreciated that the beam B can alternatively/additionally be moveable, while the object table and/or the array of individually controllable elements can have a fixed position to provide the required relative movement. Such an arrangement can assist in limiting the size of the apparatus. As a further alternative, which can, e.g., be applicable in the manufacture of flat panel displays, the position of the substrate table WT and the projection system PS can be fixed and the substrate W can be arranged to be moved relative to the substrate table WT. For example, the substrate table WT can be provided with a system for scanning the substrate W across it at a substantially constant velocity.

As shown in FIG. 1, the beam of radiation B can be directed to the patterning device PD by means of a beam splitter BS configured such that the radiation is initially reflected by the beam splitter and directed to the patterning device PD. It should be realized that the beam of radiation B can also be directed at the patterning device without the use of a beam splitter. In one example, the beam of radiation is directed at the patterning device at an angle between 0 and 90°, e.g., between 5 and 85°, between 15 and 75°, between 25 and 65°, or between 35 and 55° (the embodiment shown in FIG. 1 is at a 90° angle). The patterning device PD modulates the beam of radiation B and reflects it back to the beam splitter BS which transmits the modulated beam to the projection system PS. It will be appreciated, however, that alternative arrangements can be used to direct the beam of radiation B to the patterning device PD and subsequently to the projection system PS. In particular, an arrangement such as is shown in FIG. 1 may not be required if a transmissive patterning device is used.

The depicted apparatus can be used in several modes:

1. In step mode, the array of individually controllable elements and the substrate are kept essentially stationary, while an entire pattern imparted to the radiation beam is projected onto a target portion C at one go (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the array of individually controllable elements and the substrate are scanned synchronously while a pattern imparted to the radiation beam is projected onto a target portion C (i.e., a single dynamic exposure). The velocity and direction of the substrate relative to the array of individually controllable elements can be determined by the (de-) magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. in pulse mode, the array of individually controllable elements is kept essentially stationary and the entire pattern is projected onto a target portion C of the substrate W using a pulsed radiation source. The substrate table WT is moved with an essentially constant speed such that the beam B is caused to scan a line across the substrate W. The pattern on the array of individually controllable elements is updated as required between pulses of the radiation system and the pulses are timed such that successive target portions C are exposed at the required locations on the substrate W. Consequently, the beam B can scan across the substrate W to expose the complete pattern for a strip of the substrate. The process is repeated until the complete substrate W has been exposed line by line.

4. In continuous scan mode, essentially the same as pulse mode except that the substrate W is scanned relative to the modulated beam of radiation B at a substantially constant speed and the pattern on the array of individually controllable elements is updated as the beam B scans across the substrate W and exposes it. A substantially constant radiation source or a pulsed radiation source, synchronized to the updating of the pattern on the array of individually controllable elements, can be used.

5. In pixel grid imaging mode, which can be performed using the lithographic apparatus of FIG. 2, the pattern formed on substrate W is realized by subsequent exposure of spots formed by a spot generator that are directed onto patterning device PD. The exposed spots have substantially the same shape. On substrate W the spots are printed in substantially a grid. In one example, the spot size is larger than a pitch of a printed pixel grid, but much smaller than the exposure spot grid. By varying intensity of the spots printed, a pattern is realized. In between the exposure flashes the intensity distribution over the spots is varied.

Combinations and/or variations on the above described modes of use or entirely different modes of use can also be employed.

The substrate table WT can further be shifted in the Z direction relative to the projection system PL. In this way the relative distance between the projection system PL and the substrate table WT can be adjusted in order to focus the pattern onto the substrate W.

The present inventors have realized that improvements in the accuracy of pattern imaging can be achieved by increasing the depth of focus of the beam.

In one example, a means of increasing the depth of focus of the beam PB. The beam PB is built up from a plurality of beam components, each beam component having a frequency spectrum about a different nominal frequency. The expression “about a frequency” as used herein is not to be interpreted as limiting the beam components to a single frequency. Indeed, each beam component can typically have a narrow bandwidth about its nominal frequency. Typically, this bandwidth can have a normal amplitude distribution, with the peak frequency at the nominal frequency. However, the frequency spectrum of each beam component need not be symmetrically distributed about the nominal frequency.

In one example, each beam component is provided by a separate source radiation beam emitted by a separate radiation source SO. A beam delivery system is arranged to deflect each source radiation beam along a common path to provide the beam PB. The plurality of beam components comprises a first beam component about a first frequency. The other beam components have frequency spectrums about frequencies that are offset from the first frequency by small frequency shifts. The maximum size of the frequency shifts is determined by the required size of the depth of focus. For instance, in one embodiment, the required depth of focus is approximately 50 μm, such that the pattern resolution on the target portion of the substrate is about 3 μm. The maximum useful difference in focal depth between two beam components is about 25 μm (half the required depth of focus). This corresponds to a maximum shift in wavelength of about 75 nm (if the first beam component has a wavelength of about 355 nm). This equates to a maximum frequency shift of about 4×10⁵ Hz. In other embodiments of the present invention, the maximum frequency shift can be about 1×10¹⁵ Hz to about 10×10¹⁵ Hz.

In one example, the use of a plurality of beam components having frequencies offset from each other results in chromatic aberration or color error. The color error occurs both axially (along the direction of the beam) and laterally (transverse to the direction of the beam). The axial color error is responsible for the increase in depth of focus. Lateral color error results in variation in magnification across the projected beam, and is therefore undesirable. For one embodiment of the present invention, which includes a micro lens array, the lateral color error is minimal. This is because the array of individually controllable elements has a smaller numerical aperture than the micro lens array, e.g., about 0.001 and about 0.1, respectively. For a typical first wavelength of about 355 μm, the axial color error is approximately 0.34 μm for each shift in wavelength of 1 nm between beam components. This axial color error can be increased by dispersion within the micro lens array (typically made of quartz). Higher axial color errors could be obtained by the use of different materials for the micro lens array and arranging for the micro lens array to have a higher numerical aperture.

In one embodiment of the present invention, the plurality of beam components is supplied by five source radiation beams, each source radiation beam having a different nominal frequency.

One or more embodiments of the present invention further relate to a beam delivery system, as well as a lithographic apparatus including such a beam delivery system, and an associated device manufacturing method, together with a device, e.g., a FPD manufactured thereby.

In one example, each of the source radiation beams is supplied by a laser. The lasers are combined within the beam delivery system by using either a diffractive or a reflective optical element.

FIG. 2 illustrates a schematic side view in cross section of a portion of the projection system PL of FIG. 1, according to one embodiment of the present invention. The patterned beam 1 is focused by a lens 2 (the field lens) such that it forms a parallel patterned beam 3. The parallel patterned beam 3 illuminates a micro lens array 4. The micro lens array 4 comprises an array of micro lenses 5 that correspond to the array of individually controllable elements. Each micro lens 5 focuses the portion of the patterned beam, corresponding to an individual element, within the array of elements to form a spot on the upper surface 6 of the wafer W.

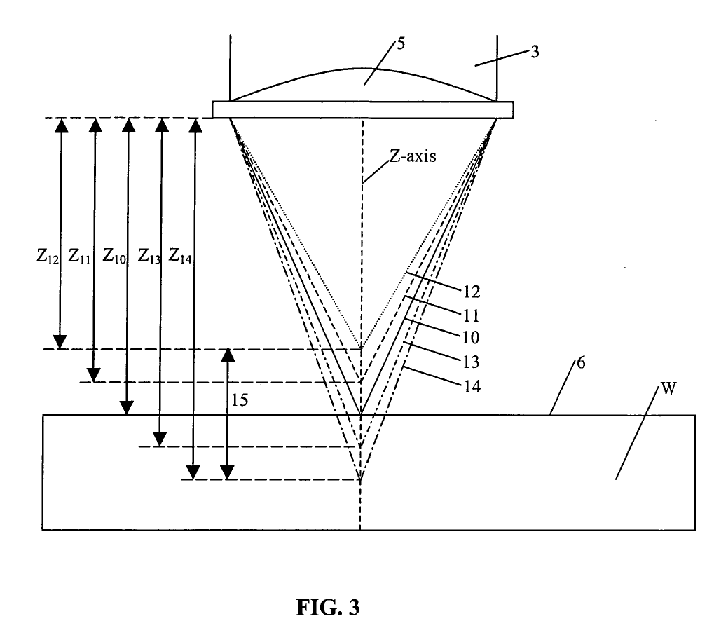

FIG. 3 illustrates an enlarged schematic side view representation of one micro lens 5, according to one embodiment of the present invention. As described above, the beam comprises a plurality of beam components. Each beam component has a frequency spectrum about a different nominal frequency. The parallel patterned beam 3 therefore can be considered to be a composite beam comprising five component beams at different frequencies. The micro lens 5 focuses each beam component at a different focal length along the Z-axis. For instance a first component 10 is focused at focal length Z₁₀ such that it is exactly focused onto the upper surface 6 of wafer W. Each other component (11, 12, 13, 14) is chosen such that it is focused at a different focal length (Z₁₁, Z₁₂, Z₁₃, Z₁₄ respectively). The variation in focal length is exaggerated for clarity. Consequently, each component is either focused onto the surface 6 of wafer W (component 10), just above surface 6 (components 11 and 12) or at a distance such that the focal length of the beam component is just below the surface 6 (components 13 and 14).

Each component 10-14 images a spot onto the surface 6 of the wafer W corresponding to the same element within the array of individually controllable elements. In this way a composite image of the spot is built up on the surface 6.

The patterned beam has a greater depth of focus than each of the individual source radiation beam components from which it formed. The depth of focus of the composite beam is indicated by arrow 15. It is equal to the difference between the longest focal length and the shortest focal length of the beam component beams.

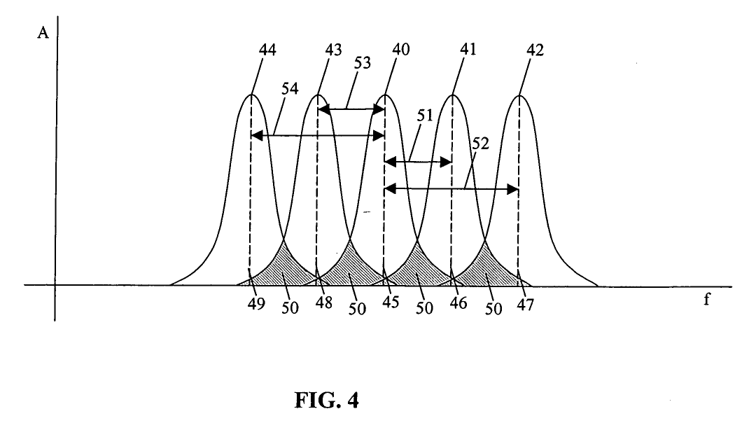

FIG. 4 illustrates a frequency spectrum of the beam of FIG. 3 with the amplitude A of the beam plotted against frequency f, according to one embodiment of the present invention. The frequency spectrum comprises five beam components 40-44 corresponding to the five component beams 10-14 of FIG. 3 respectively. Each beam component 40-44 is an approximately normal distribution, centered about a peak frequency 45-49 respectively. The peak frequencies 45-49 can be considered to be the nominal frequencies for each beam component. Each beam component overlaps its neighboring beam components in the shaded regions 50. Each beam component 41-44 has a frequency shift from its peak frequency 46-49 to the peak frequency 45 of the first beam component 40.

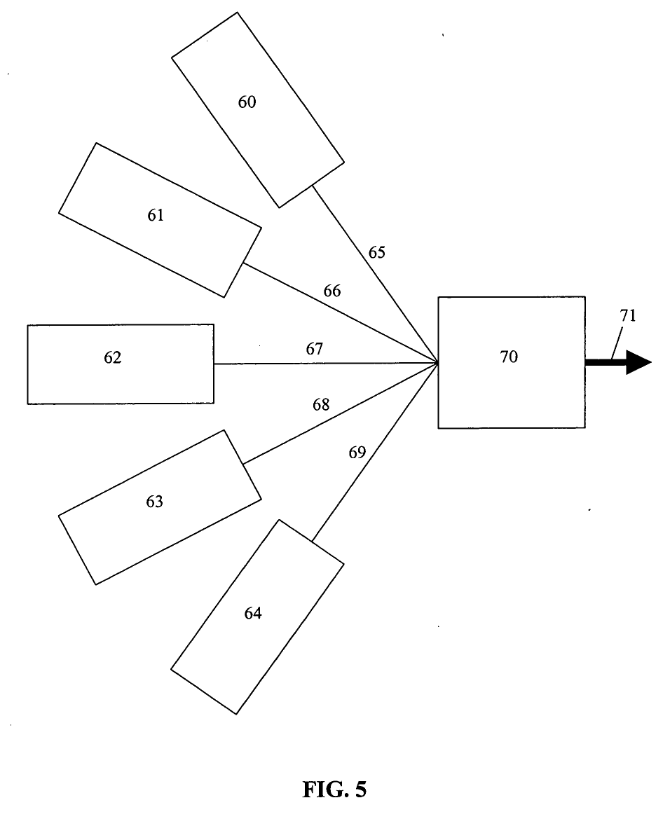

FIG. 5 illustrates a beam delivery system BD, according to one embodiment of the present invention. For example, beam delivery system BD can be used in the lithographic apparatus of FIG. 1 to provide a composite beam having an increased depth of focus as depicted in FIG. 3 and a frequency spectrum as depicted in FIG. 4. Five radiation sources 60-64, each emit a source radiation beam 65-69. A beam deflecting system 70 receives the five source radiation beams. Beam deflecting system 70 outputs the composite beam 71 to the illumination system IL. The illumination system IL in turn modifies beam 71 to generate the beam PB.

The beam deflecting system 70 can be of any form known in the art. For instance, one or more Pockels cells can be used to selectively deflect and combine the individual source radiation beams. Alternatively, any form of beam deflecting system known to those skilled in the art, for instance a diffractive, refractive or reflective element can be used. The beam deflecting system is arranged to deflect each beam along a single common beam path to provide the beam.

In one or more of the above described embodiments of the present invention, each of the five beam components are described as having a frequency spectrum about a different frequency. It will be readily apparent from the teaching herein that not all the beam components need be at different frequencies, as long as there are at least two beam components at different frequencies within the beam. The size of each frequency shift can vary.

Furthermore, it will be readily apparent that there can be any number of beam components and consequently any number of source radiation beams. Five source radiation beams is merely exemplary in that for at least one implementation of the present invention it represents a compromise between an increase in the depth of focus and an increase in the complexity of the beam delivery system.

In one or more of the above described embodiments, a first beam component is focused such that the spot it images is coincident with the surface of the wafer. However, all of the different beam components making up the beam can have peak frequencies chosen such that all beam components are focused just above and/or below the surface of the wafer.

The number of source radiation beams, the frequency shift between each beam component, and consequently the depth of focus for the beam, can be varied in response to measurement of the surface of the substrate. Specifically, the focus budget of the surface of the wafer can be calculated. If there is an increased focus budget, then the number of source radiation beams and/or the size of the frequency shifts can be increased. This results in an increase in the depth of focus such that there is a sufficient margin between the depth of focus and the focus budget.

In one or more of the above described embodiments of the present invention, the beam comprises a composite beam formed from a plurality of beam components combined and used to project a pattern onto the surface of the wafer simultaneously. Alternatively, each source radiation beam can be supplied sequentially, with the imaged pattern being built up by a number of pulses of the beam. In each pulse of the beam the beam is formed from a separate beam component or a subset of the total number of beam components. The duration of each pulse and/or each series of pulses is preferably short enough that significant relative movement between the lithographic apparatus and the wafer can be avoided.

In one or more of the above described embodiments, each beam component corresponds to a separate source radiation beam. A beam delivery system is arranged to combine the source radiation beams into a composite beam and supply this composite beam to the illumination system to generate the beam of radiation. However, in alternative embodiments of the present invention, two or more beam components are supplied by a single source radiation beam from a single radiation source. If the beam components are to be supplied sequentially then the radiation source is arranged to have a controllable frequency of emitted radiation. The frequency of the source radiation beam is changed between each pulse. However, if the beam components are to be supplied simultaneously then the single radiation source is arranged to emit a source radiation beam having a complex frequency spectrum, for instance corresponding to that shown in FIG. 4.

The composite beam can be supplied to more than one patterning system. For instance, in a lithographic apparatus for fabricating FPDs a plurality of patterning systems, e.g., arrays of individually controllable elements can be arranged such that their combined width is greater than that of a FPD substrate scanned beneath the arrays.

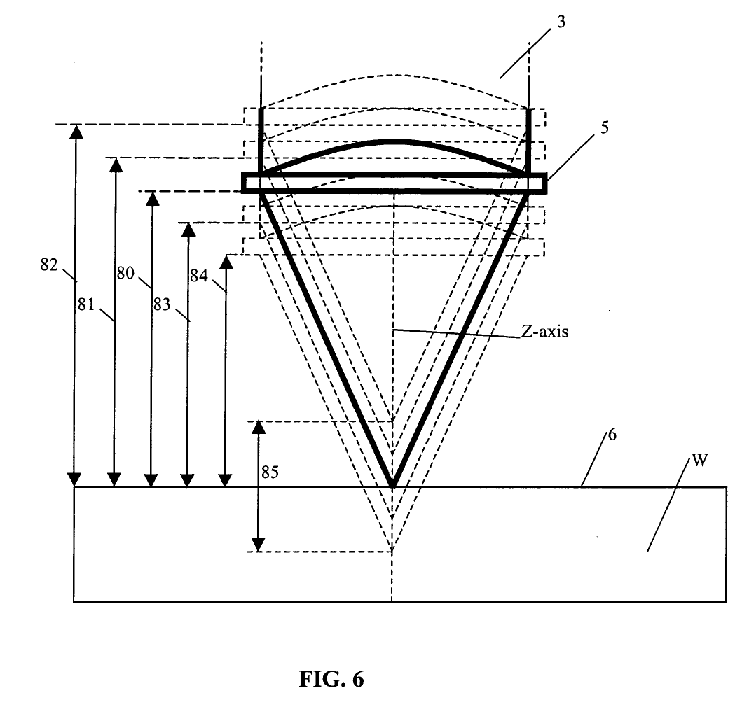

FIG. 6 illustrates an alternative embodiment of the present invention. FIG. 6 is a schematic side view of one micro lens 5. For this embodiment of the present invention, the patterning system PPM comprises an array of individually controllable elements. The present inventors have realized that, in one example, an increase in the depth of focus for a maskless lithography apparatus can be achieved by varying the height relative to the substrate table at which the pattern is focused. In this manner, a similar composite pattern can be built up sequentially to that built up by the embodiment of FIG. 3.

In FIG. 6, the beam comprises a single beam component, having a frequency spectrum about a single nominal frequency. The parallel patterned beam 3 is focused onto an array of micro lenses 5. Only a single micro lens 5 is shown in FIG. 6 for clarity. Initially the micro lens 5 is in a first position, such that the relative distance between the micro lens 5 and the substrate table WT is indicated by arrow 80. The patterned beam 3 is projected onto the surface 6 of substrate W. The micro lens 5 is then moved to at least one further position, such that the relative distance between the micro lens 5 and the substrate table WT varies. FIG. 6 shows the micro lens 5 in a further four positions, depicted by arrows 81-84. This gives rise to an increased depth of focus, as indicated by arrow 85.

For each position, the focal length of the micro lens 5 remains the same, such that the height at which the patterned beam is focused varies, for instance to just above and just below the surface 6 of substrate W. This sequential build up of the pattern can take place with the beam PB turned off during movement of the array of micro lenses 5. Alternatively, the beam PB can be continuously supplied.

It will be appreciated that as an alternative, or in addition, to moving the array of micro lenses 5, the substrate W (and the substrate table WT) can be moved in the Z direction to achieve variation in the relative distance between the projection system PL and the substrate table WT. Additionally, it will be appreciated that, as an alternative, the variation in depth of focus in this embodiment for a single beam frequency can be achieved by altering the projection system, such that its focal length varies, while maintaining a fixed distance between the projection system PL and the substrate table WT.

Although specific reference can be made in this text to the use of lithographic apparatus in the manufacture of a specific device (e.g., an integrated circuit or a flat panel display), it should be understood that the lithographic apparatus described herein can have other applications. Applications include, but are not limited to, the manufacture of integrated circuits, integrated optical systems, guidance and detection patterns for magnetic domain memories, flat-panel displays, liquid-crystal displays (LCDs), thin-film magnetic heads, micro-electromechanical devices (MEMS), etc. Also, for instance in a flat panel display, the present apparatus can be used to assist in the creation of a variety of layers, e.g., a thin film transistor layer and/or a color filter layer.

Although specific reference can have been made above to the use of embodiments of the present invention in the context of optical lithography, it will be appreciated that the present invention can be used in other applications, for example imprint lithography, where the context allows, and is not limited to optical lithography. In imprint lithography topography in a patterning device defines the pattern created on a substrate. The topography of the patterning device can be pressed into a layer of resist supplied to the substrate whereupon the resist is cured by applying electromagnetic radiation, heat, pressure or a combination thereof. The patterning device is moved out of the resist leaving a pattern in it after the resist is cured.

### CONCLUSION

While various embodiments of the present invention have been described above, it should be understood that they have been presented by way of example only, and not limitation. It will be apparent to persons skilled in the relevant art that various changes in form and detail can be made therein without departing from the spirit and scope of the present invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

What is claimed is:

1. A lithographic apparatus, comprising:
an illumination system that supplies a beam of radiation, the beam of radiation comprising a plurality of beam components including,
a first beam component having a first frequency spectrum about a first frequency, and
a second beam component having a second frequency spectrum about a second frequency, the second frequency being different from the first frequency;
an array of individually controllable elements that pattern the beam of radiation;
a substrate table that supports a substrate; and
a projection system that projects the patterned beam onto a target portion of the substrate, the projection system focusing the first and second beam components at different heights with respect to the substrate table.

2. The lithographic apparatus of claim 1, wherein the beam of radiation further comprises third, fourth, and fifth beam components.

3. The lithographic apparatus of claim 1, wherein the projection system is arranged to focus at least one of the first and second beam components at a height corresponding to a surface of the target portion.

4. The lithographic apparatus of claim 1, wherein the frequency spectra of the first and second beam components overlap.

5. The lithographic apparatus of claim 1, wherein the difference between the first frequency and the second frequency is less than about 4×10¹⁵ Hz.

6. The lithographic apparatus of claim 1, wherein the projection system comprises an array of lenses arranged to receive the patterned beam.

7. The lithographic apparatus of claim 6, wherein the projection system projects the patterned beam as an array of radiation spots based on the array of lenses.

8. The lithographic apparatus of claim 1, wherein the illumination system supplies the plurality of beam components simultaneously.

9. The lithographic apparatus of claim 1, wherein the illumination system supplies the plurality of beam components sequentially.

10. The lithographic apparatus of claim 1, wherein the illumination system supplies a series of pulses of radiation, each pulse of radiation comprising a respective one of the plurality of beam components.

11. The lithographic apparatus of claim 1, wherein the illumination system comprises a plurality of radiation sources, each source in the plurality of radiation sources being arranged to provide a respective one of the beam components.

12. The lithographic apparatus of claim 11, wherein each radiation source comprises a respective laser.

13. The lithographic apparatus of claim 11, wherein the illumination system further comprises a beam deflection system that receives the plurality of beam components and directs each of the plurality of beam components along a single common beam path.

14. The lithographic apparatus of claim 1, wherein the illumination system supplies the beam of radiation to a plurality of the array of individually controllable elements.

15. The lithographic apparatus of claim 1, further comprising:
a control system that controls the substrate table to vary the focus height while a constant pattern is imparted to the beam.

16. A device manufacturing method, comprising:
supplying a beam of radiation from an illumination system comprising a plurality of beam components including a first beam component having a first frequency spectrum about a first frequency and at least a second beam component having a second frequency spectrum about a second frequency, the second frequency being different from the first frequency;
using an array of individually controllable elements to pattern the beam; and
projecting the patterned beam onto a target portion of a substrate supported by a substrate table, such that the first and second beam components are focused at different heights with respect to the substrate table.

17. The device manufacturing method of claim 16, wherein the projecting step comprises projecting the plurality of beam components simultaneously.

18. The device manufacturing method of claim 16, wherein the projecting step comprises projecting the plurality of beam components sequentially.

19. The device manufacturing method of claim 16, wherein the beam of radiation comprises a series of pulses of radiation, each pulse of radiation comprising a separate one of the plurality of beam components.

20. The device manufacturing method of any claim 16, further comprising:
receiving the plurality of beam components from a plurality of respective radiation sources; and
deflecting each one of the plurality of beam components along a single common beam path to the array of individually controllable elements.

21. A device manufactured using a method according to claim 16.

22. A flat panel display manufactured using a method according to claim 16.

23. A device manufacturing method, comprising:
using an array of individually controllable elements to impart a beam of radiation with a pattern; and
projecting the patterned beam of radiation onto a target portion of a substrate, the projecting comprising,
sequentially focusing the patterned beam at a plurality of different heights with respect to a surface of the substrate, and
projecting the patterned beam onto a common target portion of the substrate as a corresponding array of radiation spots for each of the plurality of different heights.

24. The device manufacturing method of claim 23, further comprising:
using a projection system to focus and project the patterned beam; and
moving the projection system relative to the substrate to focus the patterned beam at the plurality of different heights.

25. The device manufacturing method of claim 24, further comprising:
supporting the substrate on a substrate table and moving the substrate table to achieve the relative movement.

26. A device manufactured using a method according to claim 23.

27. A flat panel display manufactured using a method according to claim 23.
